(19) United States
(12) Patent Application Publication
(10) Pub. No.: US 2013/0017856 A1
(43) Pub. Date: Jan. 17, 2013

(54) METHOD AND APPARATUS FOR RANGING POWER CONTROL FOR MACHINE-TO-MACHINE COMMUNICATIONS

(71) Applicants: Ronald G. Murias, Calgary (CA); Lei Wang, San Diego, CA (US)

(72) Inventors: Ronald G. Murias, Calgary (CA); Lei Wang, San Diego, CA (US)

(73) Assignee: INTERDIGITAL PATENT HOLDINGS, INC., Wilmington, DE (US)

(21) Appl. No.: 13/546,741

(22) Filed: Jul. 11, 2012

Related U.S. Application Data
(60) Provisional application No. 61/507,844, filed on Jul. 14, 2011.

(51) Int. Cl. H04W 52/18

(52) U.S. Cl. 455/522

(57) ABSTRACT

A wireless transmit/receive unit (WTRU) may select a ranging code and a ranging opportunity randomly for a ranging procedure. After sending the selected ranging code in the selected ranging opportunity, if a collision is detected, the base station may send a broadcast message including a ranging channel collision notification indicating occurrence of a collision. In that case, the WTRU may select another ranging code and another ranging opportunity, and send the ranging code without increasing a transmit power. The broadcast message may include a ranging region identification where the collision occurred.

### CROSS REFERENCE TO RELATED APPLICATIONS

This application claims the benefit of U.S. Provisional Patent Application No. 61/507,844 filed Jul. 14, 2011, which is incorporated by reference as if fully set forth.

### BACKGROUND

A new Third Generation Partnership Project (3GPP) work item has been introduced for radio access network (RAN) improvements for machine-type communications (MTC). Machine type communication is a form of data communication which involves one or more entities that do not necessarily need human interaction. A service optimized for machine type communications differs from a service optimized for human to human communications. Machine type communications are different as compared to current mobile network communication services because they involve different market scenarios, data communications, lower costs and effort, potentially very large number of communicating terminals, and to a large extent, little traffic per terminal. Metering devices or tracking devices are typical examples of MTC devices.

About sixteen categories of features have been defined for MTC, each of them bringing different design challenges: time controlled, time tolerant, packet switched (PS) only, online small data transmissions, offline small data transmissions, mobile originated only, infrequent mobile terminated, MTC monitoring, offline indication, jamming indication, priority alarm message (PAM), extra low power consumption, secure connection, location specific trigger, and group based MTC features including group based policing and group based addressing.

IEEE 802.16p is working on an amendment containing enhancements to support machine-to-machine (M2M) applications. The 802.16p project authorization request specifies medium access control (MAC) and orthogonal frequency division multiple access (OFDMA) physical layer (PHY) modifications to support lower power consumption at the device, support by the base station of a significantly larger number of devices, efficient support for small burst transmissions, and improved device authentication.

### SUMMARY

A WTRU may select a ranging code and a ranging opportunity randomly for a ranging procedure. After sending the selected ranging code in the selected ranging opportunity, if a collision is detected, the base station may send a broadcast message including a ranging channel collision notification indicating occurrence of a collision. In that case, the WTRU may select another ranging code and another ranging opportunity, and send the ranging code without increasing a transmit power. The broadcast message may include a ranging region identification where the collision occurred.

### BRIEF DESCRIPTION OF THE DRAWINGS

A more detailed understanding may be had from the following description, given by way of example in conjunction with the accompanying drawings wherein:

FIG. 1A is a system diagram of an example communications system in which one or more disclosed embodiments may be implemented;

FIG. 1B is a system diagram of an example wireless transmit/receive unit (WTRU) that may be used within the communications system illustrated in FIG. 1A;

FIG. 1C is a system diagram of an example radio access network and an example core network that may be used within the communications system illustrated in FIG. 1A; and

FIG. 2 shows a flow diagram of a procedures for collision detection and notification in accordance with one embodiment.

### DETAILED DESCRIPTION

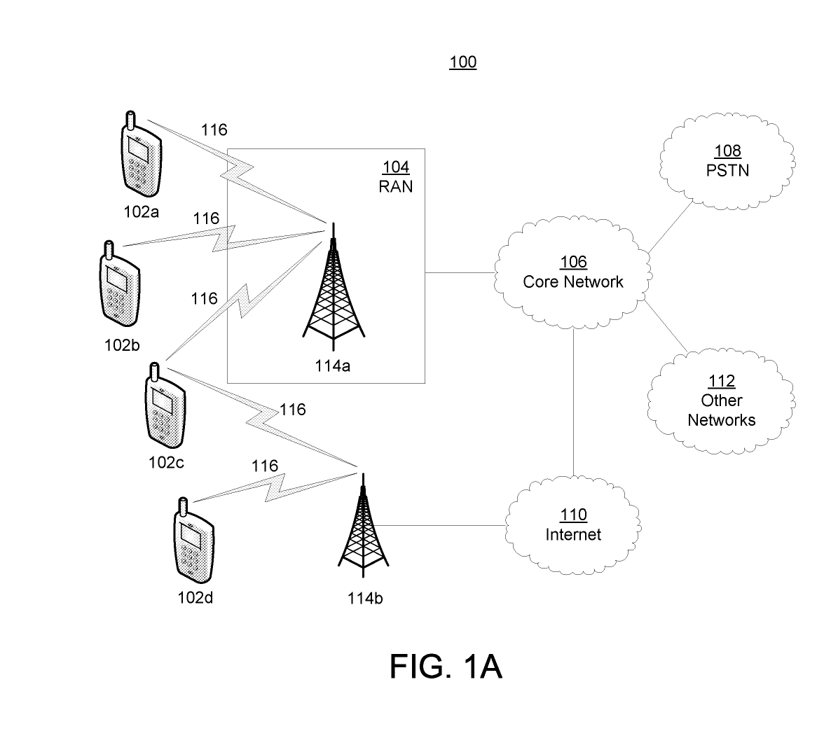

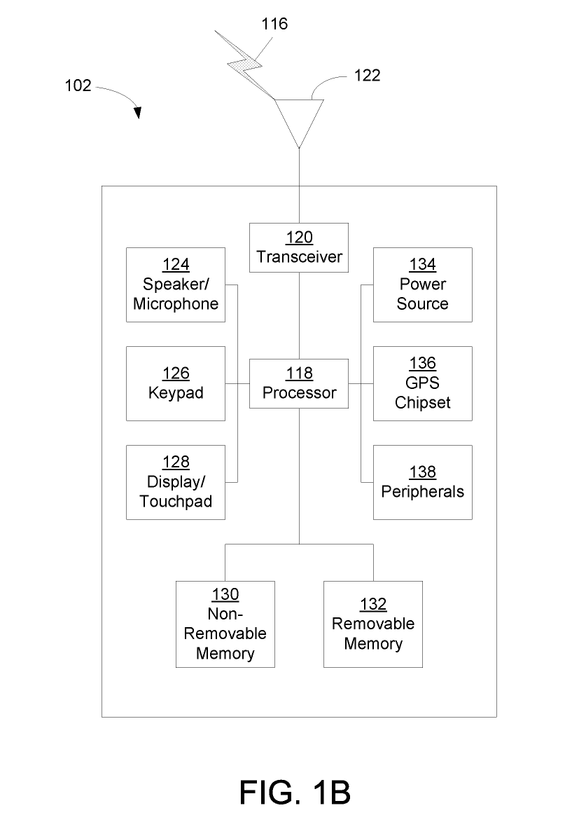

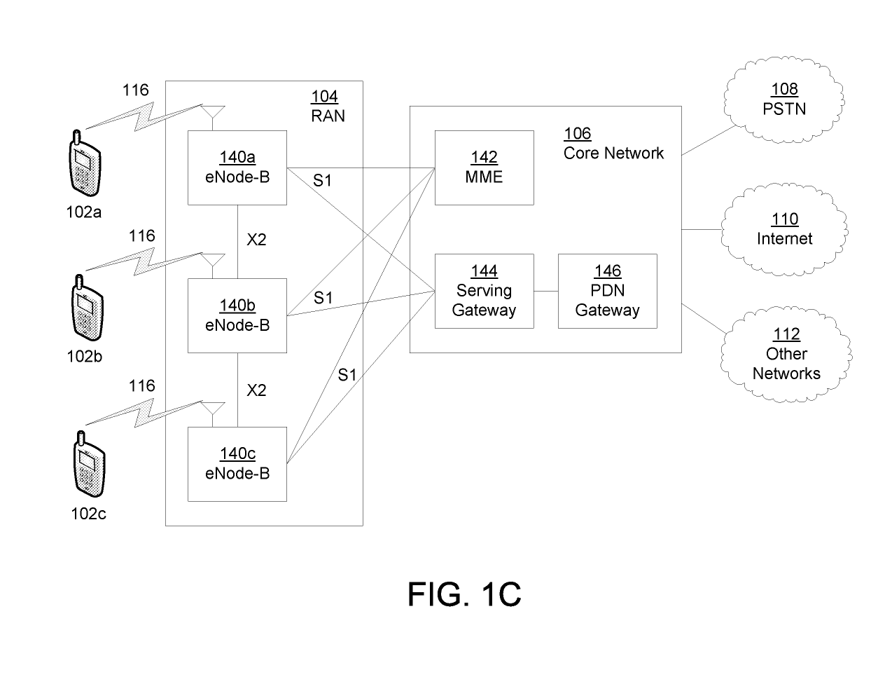

FIG. 1A is a diagram of an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), and the like.

As shown in FIG. 1A, the communications system 100 may include wireless transmit/receive units (WTRUs) 102a, 102b, 102c, 102d, a radio access network (RAN) 104, a core network 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d may be configured to transmit and/or receive wireless signals and may include user equipment (UE), a mobile station, a fixed or mobile subscriber unit, a pager, a cellular telephone, a personal digital assistant (PDA), a smartphone, a laptop, a netbook, a personal computer, a wireless sensor, consumer electronics, and the like.

The communications systems 100 may also include a base station 114a and a base station 114b. Each of the base stations 114a, 114b may be any type of device configured to wirelessly interface with at least one of the WTRUs 102a, 102b, 102c, 102d to facilitate access to one or more communication networks, such as the core network 106, the Internet 110, and/or the networks 112. By way of example, the base stations 114a, 114b may be a base transceiver station (BTS), a Node-B, an eNode B, a Home Node B, a Home eNode B, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, etc. The base station 114a and/or the base station 114b may be configured to transmit and/or receive wireless signals within a particular geographic region, which may be referred to as a cell (not shown). The cell may further be divided into cell sectors. For example, the cell associated with the base station 114a may be divided into three sectors. Thus, in one embodiment, the base station 114a may include three transceivers, i.e., one for each sector of the cell. In another embodiment, the base station 114a may employ multiple-input multiple output (MIMO) technology and, therefore, may utilize multiple transceivers for each sector of the cell.

The base stations 114a, 114b may communicate with one or more of the WTRUs 102a, 102b, 102c, 102d over an air interface 116, which may be any suitable wireless communication link (e.g., radio frequency (RF), microwave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In another embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A).

In other embodiments, the base station 114a and the WTRUs 102a, 102b, 102c may implement radio technologies such as IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, and the like. In one embodiment, the base station 114b and the WTRUs 102c, 102d may implement a radio technology such as IEEE 802.11 to establish a wireless local area network (WLAN). In another embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, etc.) to establish a picocell or femtocell. As shown in FIG. 1A, the base station 114b may have a direct connection to the Internet 110. Thus, the base station 114b may not be required to access the Internet 110 via the core network 106.

The RAN 104 may be in communication with the core network 106, which may be any type of network configured to provide voice, data, applications, and/or voice over internet protocol (VoIP) services to one or more of the WTRUs 102a, 102b, 102c, 102d. For example, the core network 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the core network 106 may be in direct or indirect communication with other RANs that employ the same RAT as the RAN 104 or a different RAT. For example, in addition to being connected to the RAN 104, which may be utilizing an E-UTRA radio technology, the core network 106 may also be in communication with another RAN (not shown) employing a GSM radio technology.

The core network 106 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and the internet protocol (IP) in the TCP/IP internet protocol suite. The networks 112 may include wired or wireless communications networks owned and/or operated by other service providers. For example, the networks 112 may include another core network connected to one or more RANs, which may employ the same RAT as the RAN 104 or a different RAT.

Some or all of the WTRUs 102a, 102b, 102c, 102d in the communications system 100 may include multi-mode capabilities, i.e., the WTRUs 102a, 102b, 102c, 102d may include multiple transceivers for communicating with different wireless networks over different wireless links. For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram of an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 106, removable memory 132, a power source 134, a global positioning system (GPS) chipset 136, and other peripherals 138. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In another embodiment, the transmit/receive element 122 may be an emitter/detector configured to transmit and/or receive IR, UV, or visible light signals, for example. In yet another embodiment, the transmit/receive element 122 may be configured to transmit and receive both RF and light signals. It will be appreciated that the transmit/receive element 122 may be configured to transmit and/or receive any combination of wireless signals.

In addition, although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as UTRA and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 106 and/or the removable memory 132. The non-removable memory 106 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs or video), a universal serial bus (USB) port, a vibration device, a television transceiver, a hands free headset, a Bluetooth® module, a frequency modulated (FM) radio unit, a digital music player, a media player, a video game player module, an Internet browser, and the like.

FIG. 1C is a system diagram of the RAN 104 and the core network 106 according to an embodiment. As noted above, the RAN 104 may employ an E-UTRA radio technology to communicate with the WTRUs 102a, 102b, 102c over the air interface 116. The RAN 104 may also be in communication with the core network 106.

The RAN 104 may include eNode-Bs 140a, 140b, 140c, though it will be appreciated that the RAN 104 may include any number of eNode-Bs while remaining consistent with an embodiment. The eNode-Bs 140a, 140b, 140c may each include one or more transceivers for communicating with the WTRUs 102a, 102b, 102c over the air interface 116. In one embodiment, the eNode-Bs 140a, 140b, 140c may implement MIMO technology. Thus, the eNode-B 140a, for example, may use multiple antennas to transmit wireless signals to, and receive wireless signals from, the WTRU 102a.

Each of the eNode-Bs 140a, 140b, 140c may be associated with a particular cell (not shown) and may be configured to handle radio resource management decisions, handover decisions, scheduling of users in the uplink and/or downlink, and the like. As shown in FIG. 1C, the eNode-Bs 140a, 140b, 140c may communicate with one another over an X2 interface.

The core network 106 shown in FIG. 1C may include a mobility management gateway (MME) 142, a serving gateway 144, and a packet data network (PDN) gateway 146. While each of the foregoing elements are depicted as part of the core network 106, it will be appreciated that any one of these elements may be owned and/or operated by an entity other than the core network operator.

The MME 142 may be connected to each of the eNode-Bs 142a, 142b, 142c in the RAN 104 via an S1 interface and may serve as a control node. For example, the MME 142 may be responsible for authenticating users of the WTRUs 102a, 102b, 102c, bearer activation/deactivation, selecting a particular serving gateway during an initial attach of the WTRUs 102a, 102b, 102c, and the like. The MME 142 may also provide a control plane function for switching between the RAN 104 and other RANs (not shown) that employ other radio technologies, such as GSM or WCDMA.

The serving gateway 144 may be connected to each of the eNode Bs 140a, 140b, 140c in the RAN 104 via the S1 interface. The serving gateway 144 may generally route and forward user data packets to/from the WTRUs 102a, 102b, 102c. The serving gateway 144 may also perform other functions, such as anchoring user planes during inter-eNode B handovers, triggering paging when downlink data is available for the WTRUs 102a, 102b, 102c, managing and storing contexts of the WTRUs 102a, 102b, 102c, and the like.

The serving gateway 144 may also be connected to the PDN gateway 146, which may provide the WTRUs 102a, 102b, 102c with access to packet-switched networks, such as the Internet 110, to facilitate communications between the WTRUs 102a, 102b, 102c and IP-enabled devices.

The core network 106 may facilitate communications with other networks. For example, the core network 106 may provide the WTRUs 102a, 102b, 102c with access to circuit-switched networks, such as the PSTN 108, to facilitate communications between the WTRUs 102a, 102b, 102c and traditional land-line communications devices. For example, the core network 106 may include, or may communicate with, an IP gateway (e.g., an IP multimedia subsystem (IMS) server) that serves as an interface between the core network 106 and the PSTN 108. In addition, the core network 106 may provide the WTRUs 102a, 102b, 102c with access to the networks 112, which may include other wired or wireless networks that are owned and/or operated by other service providers.

With the deployment of M2M systems, a wide variety of devices with diverse capabilities can be envisioned to be operating under different conditions. One expectation common to both the 3GPP work item and the IEEE 802.16p project authorization request is that there will be a significantly larger number of devices in a cell. This large increase in the expected number of devices requires additional consideration to aspects of functionality including network entry/re-entry.

Modern networks including 802.16 (WiMAX) and 3GPP Long Term Evolution (LTE) require a specific procedure for network entry. Typically, this process begins with a wireless transmit/receive unit (WTRU) performing cell search to find one or more base stations to which to connect. Following the cell search, a base station is selected and the WTRU monitors a downlink signal to obtain coarse synchronization, cell identification, and system configuration parameters for that cell. Next, the WTRU performs ranging and synchronization, typically followed by basic capability negotiation, authentication and authorization, etc. before registering with the base station and establishing service flows. After establishing a connection and possibly exchanging control and data, the WTRU may enter an idle mode where it is no longer in regular communication with the base station, and when it is paged or needs to transfer data, it may need to perform the ranging procedure again before any control or data can be transferred.

The ranging procedure is as follows. A WTRU randomly selects a ranging opportunity and a ranging code (typically from a set of codes designed to be easily detected while orthogonal to one another) to transmit during that ranging opportunity. For LTE, this is referred to as a random access preamble, and it is transmitted on a time-frequency resource known as the Physical Random-Access Channel (PRACH). The time and location of these opportunities is transmitted by the base station. Before transmitting a ranging code, the WTRU selects an initial transmit power setting. This initial power setting may be based on a path loss estimate made by the WTRU, the last transmit power setting used, the lowest power setting available to the WTRU, or some other starting point may be used.

Once the ranging code is transmitted, if the base station successfully decodes that code, it responds to the WTRU and the network entry procedure continues. However, there are cases where the base station is unable to decode the ranging signal with sufficient confidence that it is correct. This may be due to a WTRU's transmit power setting that is too low, or it may be because one or more other WTRUs transmitted ranging codes during the same ranging opportunity. If the base station is not able to decode the ranging signal with sufficient confidence, it will not respond to the WTRU(s). Without the correct codes, the base station is unable to acknowledge the WTRU(s) who transmitted those codes, so current LTE and IEEE 802.16 systems simply do not respond if they are unable to decode.

If the base station does not respond to the WTRU (i.e., the ranging code was not correctly decoded or the base station did not receive the ranging code) within a pre-defined response-time window, the WTRU randomly selects a new code, increases transmit power, (for example, in 802.16m, the power is increased by 2 dB), within its maximum allowed level, and, after a random back-off, the WTRU attempts ranging again using the new ranging code, the new ranging slot, and a higher power setting. This process continues until the number of retries has been exhausted, or the base station responds and the device is able to enter the network.

One significant issue with M2M systems is that there are typically a large number of devices which may need to perform this ranging task, either for initial entry into the network or to re-synchronize after a long idle period. Because ranging opportunities are limited and the number of M2M devices is large, there is an increased likelihood that two or more devices would attempt to perform ranging at the same time. This means that several ranging codes would be transmitted during the same ranging slot.

When several ranging codes are transmitted during the same ranging slot, there are several possibilities that may result:

(a) Multiple WTRUs select the same ranging slot (or called ranging channel), each WTRU is transmitting a distinct code, and the base station is able to decode all of the ranging codes;

(b) Multiple WTRUs select the same ranging slot (or called ranging channel), each WTRU is transmitting a distinct code, and the base station is unable to correctly decode some or all of the codes. In this case, the base station may detect power on the ranging channel, but because it cannot decode the signals, it is unable to acknowledge any of the devices who are ranging; and

(c) Two or more WTRUs simultaneously transmit the same code in the same ranging slot, and the base station is unable to determine that more than one WTRU has transmitted the same code during the same slot. In this case, the base station will unwittingly acknowledge more than one device with the same code.

In the case of (a), there is no problem, as each WTRU will get a response from the base station and network entry will continue as usual.

In the case of (c), an allocation will be provided and both (or several) WTRUs would realize the conflict later in the process. This procedure is called random access (RA)-initiated data region collision. That is, data region collision occurs at a data region allocation initiated by RA with a missed-detection of ranging channel access collision. Some base station (BS)-assistance schemes may be used to timely inform the WTRUs involved in the RA-initiated data region collision by sending a negative acknowledgement (NACK) control signal for the specific RA-initiated uplink (UL) data allocation, or if UL synchronized hybrid automatic repeat request (HARQ) is used, terminating the UL allocations for the synchronized HARQ retransmissions.

In the case of (b), because the base station cannot correctly decode the codes that were transmitted, it does not respond to any code that it cannot (with some level of confidence) decipher. Any WTRU that does not receive a response within a pre-defined time period will assume failure and follow the procedure: select a new code, increase power, and wait a random backoff time before attempting the ranging process again.

The problem with this process is that it was designed for a network where a large number of collisions were not expected. The most likely reason for a failed ranging attempt is that the device is out of range of the base station, so it makes sense to increase power for each attempt.

However, with many more collisions expected in M2M networks, many WTRUs will assume ranging failure, then select a new ranging code and ranging slot and transmit again with an (often unnecessary) increase in power. Because of this, most WTRUs may end up wasting power and causing interference due to collisions during the ranging process.

In order to solve the above identified issues, in one embodiment, a new broadcast message is introduced that is sent from the base station any time a collision is detected to notify the ranging WTRUs that the base station received a signal on a specified ranging channel/slot, but it was unable to decode it. As a result, the WTRUs may choose not to increase the power before sending their next ranging code, and instead select a random backoff and a new code.

In another embodiment, mobility-status-specific power setting ranges may be introduced for network reentries, (e.g., different power setting ranges for fixed devices and mobile devices, etc.)

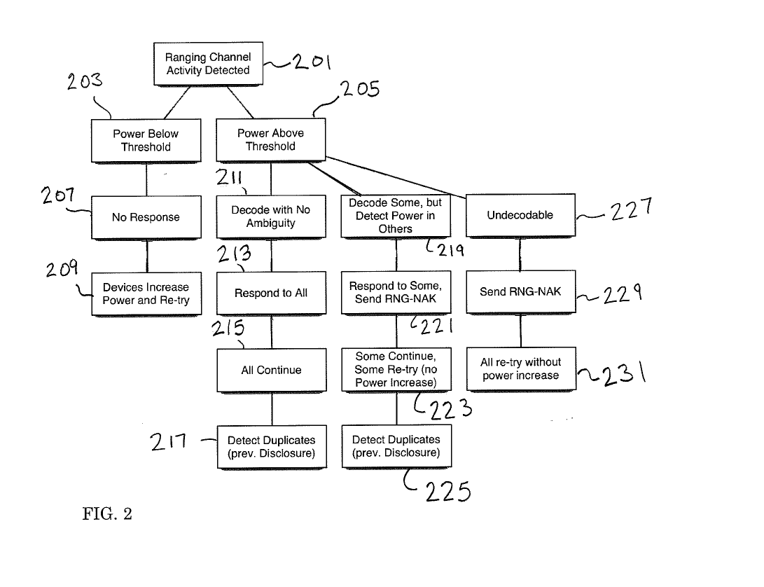

Embodiments for collision detection notification are disclosed hereafter. FIG. 2 shows a flow diagram of a procedures for collision detection and notification in accordance with one embodiment.

The base station is capable of detecting activity or energy on the ranging channel, as shown in Step 201 in FIG. 2. Frequency domain detection helps eliminate false detection caused by interference spikes. Once energy is detected, the base station may make a decision regarding the source(s) of that energy. The code(s) used in transmission may be detected without error, and as a result, a network entry may continue as prescribed in the normal procedure.

In case where ranging energy is detected but the ranging codes cannot be decoded, the base station may broadcast a signal indicating this case so that the WTRUs know that power increase is not necessary. In this case, the detected energy may be above a level that would indicate insufficient transmit power from a WTRU. In other words, at least two thresholds may be considered: a first threshold below which the base station assumes no ranging has been attempted, and a second threshold below which the base station assumes a ranging attempt has been made, but with insufficient transmit power 203. The detected energy above the second threshold 205 that is still not decodable may be treated as a collision.

In case where some ranging codes are correctly detected, but some have collided, the base station may detect the collision by subtracting the power of the detected codes from the total power measured on the ranging channel. If this power level exceeds the detection threshold, a collision may be detected 205. In this case, a normal ranging procedure may continue for each of the detected codes, and the base station may broadcast a collision notice for that ranging channel.

The WTRU proceeds normally with network entry when it receives a response to its transmission of a ranging code. If it does not receive a direct response from the base station 207, the WTRU may receive a collision broadcast message, or none. If there is no collision broadcast message, the WTRU may carry out the normal re-try procedure, (i.e., randomly select a new code, randomly select a new ranging opportunity, increase power within its maximum allowed level, and try again (up to a prescribed number of re-tries)) 209.

In the case where the power is above a threshold 205, there may be three alternatives. First, the ranging code is decoded with no ambiguity 211. This is leads to the eNodeB responding to all 213. The procedure continues 215 and begins duplicate detection 217.

The second alternative is that some ranging codes are decoded but others are not 219. In this scenario, the decoded signals are decoded, while the others receive an RNG-NAK response (more on this to follow) 221. The decoded signals continue while the others re-try (with no power increase) 223. Again, duplicate detection may begin. 225.

The third alternative is that all signals are undecodable 227, and the eNodeB sends a RNG-NAK signal in response 229. Finally, all machines may retry without a power increase 231.

More details of this are outlined below.

If the WTRU does not receive a ranging response from the base station and it detects a collision broadcast message from the base station indicating that a collision has occurred on the same ranging slot as the WTRU last used, the WTRU may assume that its code has collided with a code from one or more other WTRUs. In this case, the WTRU may randomly select a new code and a new ranging opportunity, but may not increase the transmit power.

The broadcast message for ranging channel collision notification may include a ranging region identification, which may be simply a frame identification if only one ranging region was allocated in the frame. The broadcast message may also include some additional descriptors to uniquely identify a ranging region allocation in a frame with multiple ranging regions, (e.g., a logical resource unit (LRU) index, a subchannel index, a symbol index, etc.). The broadcast message may include a list of ranging slots where collision was detected, where a ranging slot may be identified by its index value if the ranging slots are numbered or ordered based on certain pre-defined numbering or ordering schemes, or other descriptors.

The ranging channel collision detection notification may be signaled in a MAC control or management message, a MAC control or signaling header, a subheader, an extended header, and/or other forms of downlink (DL) control signals. For example, in 802.16m, the ranging channel collision detection notification may be implemented by introducing a new MAC control message, (called AAI-RNG-NAK). Alternatively, it may be encoded by adding a new information field(s) into an existing MAC control message, AAI-RNG-ACK, which provides responses to all the correctly decoded ranging requests in a ranging region.

Another example is to introduce the ranging channel collision detection notification into 802.16e. A new MAC control or management message may be defined to provide the ranging channel collision notification, (called RNG-NAK). Alternatively, a new MAC control or management message may be defined, (called RNG-ACK), which provides responses to all correctly decoded ranging requests and the ranging channel collision notifications for a ranging region.

The ranging ACK responses and ranging channel collision notifications for multiple ranging regions may be encoded in one control signal, (e.g., MAC control/management message), as long as the ranging requests (slot plus code) for ACK responses and the ranging slots for collision notification can be properly identified.

A WTRU may use the information provided in the ranging channel collision notification to adjust the ranging channel retransmission power, after it is sure that its previous ranging request attempt has failed. This may be used for the cases where some of the codes in a ranging slot were successfully decoded while also detecting other power in the same slot.

For LTE, random access starts with the WTRU transmitting a preamble. For the second step in the procedure, the eNodeB transmits a message on the downlink shared channel (DL-SCH) containing the index of the detected random access preamble, along with timing correction, a scheduling grant, and a temporary identity (ID). In case of a detected collision, the eNodeB may indicate on the DL-SCH (indicated on a physical downlink control channel (PDCCH)) that a collision has been detected. The timing of the response is not fixed, so the WTRU may use a combination of a collision indication with the lack of response from the eNodeB to determine that it was part of the collision.

Assume that several WTRUs transmit an RA preamble and a collision has occurred, but one or more preambles was successfully detected. In this case, the eNodeB may transmit the usual response for those codes successfully decoded, and also transmit a collision indication. The WTRU may wait a predetermined period of time before concluding that it was part of the collision and proceed with a re-try without power ramping.

Alternatively, in the event of a detected collision, the eNodeB may transmit responses for all correctly decoded preambles, then transmit the collision indication last. This way, if a WTRU receives a collision indication and has not received an indication that its preamble was successfully decoded, it may conclude that it was part of a collision without waiting any further.

Embodiments for mobility status-specific network reentry ranging power settings are disclosed hereafter.

For fixed M2M devices (i.e., WTRUs), after initialization, the attribute of fixed location may be flagged at both the base station and the M2M devices. At the network reentry from a power saving mode (e.g., idle mode), the fixed location attribute may be used to help the selection of the initial power level and to determine a power setting range for transmitting the ranging signal.

For example, the initial power level may be determined based on the available previous power level from non-volatile storage and/or the measurements on the received DL signals.

Comparing to the WTRU's full power setting range, (i.e., from the minimal transmission power to the max transmission power based on the WTRU's capacity and regulatory specifications), the ranging signal power setting for a fixed location subscriber may be expected to be of a much smaller range, (i.e., some small variances around the selected initial power level). Such small variances may be determined by the power settings used previously when connected to the base station, and/or current measurements of the received DL signals.

When the WTRU needs to adjust the transmission power level at the ranging retries, the WTRU may select the power level in the pre-determined small power setting range, so that ranging signal may be transmitted at an optimal power level and the caused interferences may be effectively minimized.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method for ranging power control for machine-to-machine (M2M) communications, the method comprising:
a wireless transmit/receive unit (WTRU) randomly selecting a first ranging code and a first ranging opportunity;
the WTRU sending the first ranging code in the first ranging opportunity;
the WTRU receiving a broadcast RNG-NAK message indicating a possible collision of the first ranging code;
in response to the RNG-NAK message, the WTRU selects a second ranging code and a second ranging opportunity; and
the WTRU sending the second ranging code in the second ranging opportunity without increasing transmit power.

2. The method of claim 1, wherein the ranging code and the ranging opportunity are selected randomly.

3. The method of claim 1, wherein the broadcast message includes a ranging region identification where the collision occurred.

4. The method of claim 3, wherein the ranging region identification is a frame identification where the collision occurred.

5. The method of claim 1, wherein the broadcast message includes a descriptor that uniquely identifies a ranging region allocation in a frame.

6. The method of claim 1, wherein the broadcast message includes a list of ranging slots where the collision occurred.

7. The method of claim 6, wherein the ranging slots are identified by index values.

8. The method of claim 1, wherein a ranging channel collision notification is signaled in a medium access control (MAC) control or management message, a MAC control or signaling header, a subheader, or an extended header.

9. The method of claim 1, wherein ranging acknowledgement responses and ranging channel collision notifications for multiple ranging regions are encoded in one control signal.

10. The method of claim 1, wherein the WTRU is a fixed M2M device.

11. The method of claim 10, wherein a transmit power level for the ranging code is pre-determined.

12. The method of claim 11, wherein the transmit power level for the ranging code is determined based on a previous power level.

13. The method of claim 1, wherein the transmit power level for the ranging code is adjusted in a predetermined power setting range.

14. A method for ranging power control for machine-to-machine (M2M) communications, the method comprising:
decoding a ranging channel in a ranging opportunity; and
sending a broadcast message indicating that a collision of the ranging channel occurred on a condition that a collision is detected, wherein the collision is detected by detecting ranging energy on the ranging channel.

15. The method of claim 14, wherein a base station employs a first threshold below which the base station assumes no ranging has been attempted, and a second threshold below which the base station assumes a ranging attempt has been made, but with insufficient transmit power.

16. The method of claim 14, wherein the detected ranging energy above the second threshold that is not decodable is treated as a collision.

17. The method of claim 14, wherein the base station detects the collision based on a power obtained by subtracting a power of detected ranging codes from a total power measured on the ranging channel.

18. The method of claim 14, wherein the broadcast message includes a ranging region identification where the collision occurred.

19. The method of claim 18 wherein the ranging region identification is a frame identification where the collision occurred.

20. A wireless transmit/receive unit (WTRU) with ranging power control for machine-to-machine (M2M) communications comprising:
a processor that randomly selects a first ranging code and a first ranging opportunity;
a transmitter that sends the first ranging code in the first ranging opportunity;
a receiver that receives a broadcast RNG-NAK message indicating a possible collision of the first ranging code;
wherein, in response to the RNG-NAK message, the processor selects a second ranging code and a second ranging opportunity the transmitter sends the second ranging code in the second ranging opportunity without increasing transmit power.
